(19) United States
(12) Patent Application Publication
(10) Pub. No.: US 2026/0313499 A1
(43) Pub. Date: Oct. 8, 2026

(54) TERMINAL DEVICE, NETWORK DEVICE AND METHODS FOR COMMUNICATIONS

(71) Applicant: LENOVO (BEIJING) LIMITED, Beijing (CN)

(72) Inventors: Ran Yue, Beijing (CN); Jing Han, Beijing (CN); Haiming Wang, Beijing (CN); Lianhai Wu, Beijing (CN); Min Xu, Beijing (CN)

(21) Appl. No.: 19/483,412

(22) PCT Filed: May 11, 2023
(86) PCT No.: PCT/CN2023/093514

§ 371 Date: Nov. 11, 2025

(51) Int. Cl. H04W 36/08; H04W 36/00; H04W 52/02

(52) U.S. Cl. CPC H04W 36/08; H04W 36/0072; H04W 52/0206

(57) ABSTRACT

Embodiments of the present disclosure relate to a solution for communications. In one aspect of the solution, a terminal device performs a handover to a first cell provided by a first network device. In turn, the terminal device receives, from the first network device, downlink transmission in the first cell.

### FIELD

Embodiments of the present disclosure generally relate to the field of communication, and in particular to terminal device, network device and methods for communications.

### BACKGROUND

Network energy saving (NES) technology is going to be supported in Release 18. According to the NES technology, a cell may be operated in energy saving mode based on a configuration related to NES for the cell. For example, the configuration related to NES may comprises at least one of a cell discontinuous reception (DRX) configuration or a cell discontinuous transmission (DTX) configuration for a terminal device in radio resource control connected (RRC_CONNECTED) mode.

In some cases, a terminal device may perform handover (HO) to a target cell. The cell DTX/DRX configuration of the target cell may be changed. However, the change cannot be informed to the terminal device when the terminal device performs access to the target cell.

### SUMMARY

In general, embodiments of the present disclosure provide a solution for communications.

In a first aspect, there is provided a terminal device. The terminal device comprises a processor and a transceiver coupled to the processor. The processor is configured to: perform a handover to a first cell provided by a first network device; and receive, via the transceiver from the first network device, downlink transmission in the first cell.

In a second aspect, there is provided a network device. The network device comprises a processor and a transceiver coupled to the processor. The processor is configured to: transmit, via the transceiver to a terminal device which performs a handover to a first cell provided by the first network device, a first configuration related to network energy saving for the first cell; and communicate with the terminal device based on the first configuration.

In a third aspect, there is provided a method performed by a terminal device. The method comprises: performing, at a terminal device, a handover to a first cell provided by a first network device; and receiving, from the first network device, downlink transmission in the first cell.

In a fourth aspect, there is provided a method performed by a network device. The method comprises: transmitting, from a first network device to a terminal device which performs a handover to a first cell provided by the first network device, a first configuration related to network energy saving for the first cell; and communicating with the terminal device based on the first configuration.

In a fifth aspect, there is provided a computer readable medium. The computer readable medium has instructions stored thereon. The instructions, when executed on at least one processor of a device, causing the device to perform the method of the third aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIGS. 1A and 1B illustrate a schematic diagram of a communication environment in which some embodiments of the present disclosure can be implemented, respectively;

FIGS. 2A and 2B illustrate an example of cell DTX configurations for a target cell and UE behavior, respectively;

FIG. 2C illustrates an example of cell DRX configurations for a target cell and UE behavior;

FIG. 3 illustrates a signaling chart illustrating an example process for communications in accordance with some embodiments of the present disclosure;

FIG. 4 illustrates a signaling chart illustrating an example process for communications in accordance with some embodiments of the present disclosure;

FIG. 5 illustrates an example of cell DTX configurations for a target cell and behavior of the terminal device;

FIGS. 6 to 8 illustrate a signaling chart illustrating an example process for communications in accordance with other embodiments of the present disclosure, respectively;

FIG. 9 illustrates an example of cell DRX configurations for a target cell and behavior of the terminal device;

FIG. 10 illustrates a signaling chart illustrating an example process for communications in accordance with still other embodiments of the present disclosure;

FIG. 11 illustrates a flowchart of a method implemented at a terminal device in accordance with some embodiments of the present disclosure;

FIG. 12 illustrates a flowchart of a method implemented at a network device in accordance with other embodiments of the present disclosure; and

FIG. 13 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

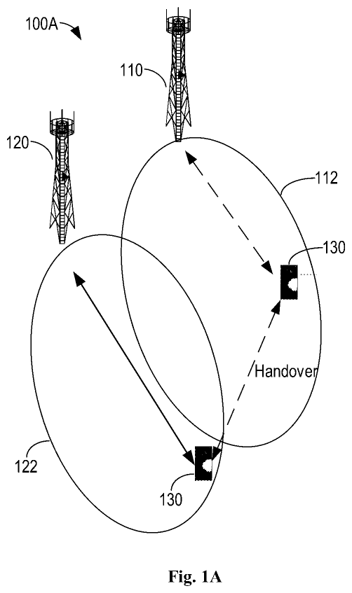

FIGS. 1A and 1B illustrate schematic diagrams of communication environments 100A and 100B in which some embodiments of the present disclosure can be implemented. Each of the communication environments 100A and 100B may comprise a first network device 110, a second network device 120, and a terminal device 130. Hereinafter, the terminal device 130 may be referred to as UE 130. The first network device 110 and the second network device 120 provide cells 112 and 122, respectively.

In some embodiments, the terminal device 130 may be in coverage of the cell 122 of the second network device 120. The terminal device 110 may move out of coverage of the cell 122 and into coverage of the cell 112 of the first network device 110. In such embodiments, handover of the terminal device 130 from the cell 122 to the cell 112 may be performed. The cell 122 and the cell 112 are referred to as a source cell 122 and a target cell 112, respectively.

In the example of FIG. 1A, the second network device 120 acts as a source network device and the first network device 110 acts as a target network device. In other words, the source network device is different from the target network device. In the present disclosure, mobility of the terminal device 130 in the example of FIG. 1A is also referred to as inter-gNB mobility.

The example of FIG. 1B is different from the example of FIG. 1A in that both the source cell 122 and the target cell 112 are provided by the first network device 110. The first network device 110 acts as both a source network device and a target network device. In other words, the source network device is the same as the target network device. In the present disclosure, mobility of the terminal device 130 in the example of FIG. 1B is also referred to as intra-gNB mobility.

In some embodiments, the handover may be triggered by a source network device via a handover command, such as the second network device 120 (in the example of FIG. 1A) or by the first network device 110 (in the example of FIG. 1B).

Alternatively, in some embodiments, the handover may be a conditional handover (CHO). The CHO is defined as a handover that is executed by the terminal device 130 when one or more handover execution conditions are met. The terminal device 130 starts evaluating one or more execution conditions upon receiving the CHO configuration, and stops evaluating the one or more execution conditions once a handover is executed.

Communications in the communication environments 100A and 100B may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some embodiments, a configuration related to NES for CHO candidate cell may be provided from a source cell to UE. For example, the configuration related to NES may comprises at least one of a cell DRX configuration or a cell DTX configuration for a UE in RRC CONNECTED mode. The UE may not monitor Physical Downlink Control Channel (PDCCH) for dynamic grants or assignments for new transmissions during Cell DTX non-active period, even if the UE is in connected-DRX (C-DRX) active time.

In some embodiments, the UE may be configured with one or multiple cell DRX configurations and/or one or multiple cell DTX configurations for a cell. Layer 1 (L1) signalling may be used to activate, deactivate or change one of the multiple cell DRX configurations or one of the multiple cell DTX configurations.

It could be possible that the UE is configured with a cell DTX/DRX (cell DTX and/or cell DRX) configuration of a target cell and considers the cell DTX/DRX configuration is activated. It could be also possible that the UE is configured with the cell DTX/DRX configuration for the target cell and considers the cell DTX/DRX configuration is deactivated. It could be also possible that the UE is configured with the multiple cell DTX/DRX configurations for the target cell and considers one of the cell DTX/DRX configurations is activated.

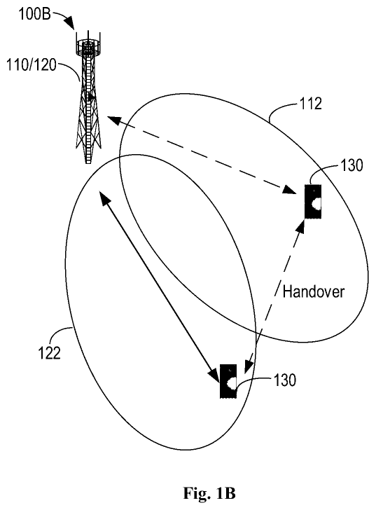

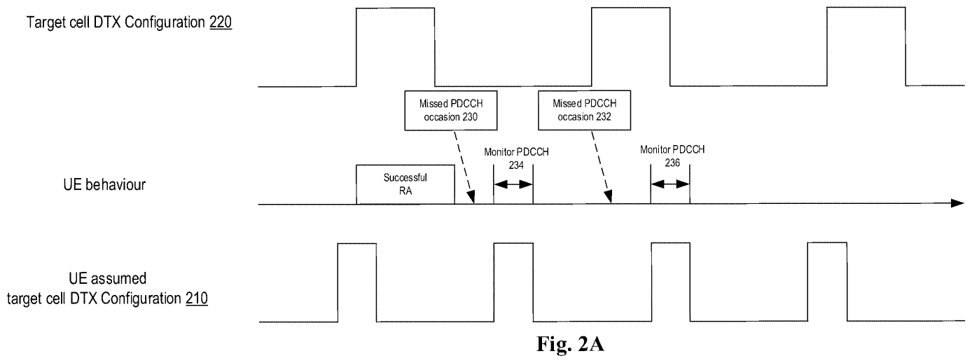

The cell DTX/DRX configuration for the target/candidate/selected candidate cell may be changed. However, the change cannot be informed to the UE when the UE performs access to the target cell. Therefore, it needs to discuss how to obtain the updated configuration for the target cell after starting to access to the target cell. This will be described with reference to FIGS. 2A and 2B.

FIGS. 2A and 2B illustrate an example of cell DTX configurations for a target cell and UE behavior, respectively.

In the example of FIG. 2A, a source network device may trigger handover of UE by transmitting a handover command to the UE. The handover command or CHO related configuration may comprise a cell DTX configuration for a candidate/target cell 210. Hereinafter, for brevity, a cell DTX configuration for a candidate/target cell is also referred to as a candidate/target cell DTX configuration. Thus, upon receiving the handover command, the UE assumes that a cell DTX configuration for a target cell is the cell DTX configuration 210 and applies the cell DTX configuration 210.

After the handover command or CHO related configuration is transmitted to the UE, a candidate/target network device may transmit a target cell DTX configuration 220 to the source network device. The target cell DTX configuration 220 is different from or misaligned with the cell DTX configuration 210. Hereinafter, the target cell DTX configuration 220 is also referred to as a new or updated target cell DTX configuration 220, and the cell DTX configuration 210 is also referred to as an old target cell DTX configuration 210. However, after receiving the handover command from the source network device or from the time when the UE starts synchronization with target cell, the UE will not receive any information from the source network device. Thus, the new target cell DTX configuration 220 cannot be informed to the UE from the source network device when the UE performs access to the target cell.

The UE may access to the target cell by performing a random access (RA) procedure to the target cell.

If the target cell is a smart target cell, one or more PDCCH occasions (such as PDCCH occasions 230 and 232) are missed or wasted. For the case where the cell DTX configuration for the target cell is updated from the old target cell DTX configuration 210 to the new target cell DTX configuration 220, no PDCCH occasion will be available if there is no overlapped active duration between the old target cell DTX configuration 210 and the new target cell DTX configuration 220. Thus, the UE cannot receive any downlink transmission from the target network device. In other words, all of the downlink transmissions may fail.

If the new target cell DTX configuration 220 is activated before the UE completes the RA procedure to the target cell, the smart target cell knows the UE monitors all of the PDCCH occasions (such as PDCCH occasions 234 and 236) based on the old target cell DTX configuration 210 which introduces unnecessary UE consumption.

In the example of FIG. 2B, handover of UE is CHO. The target cell cannot identify whether the UE applies the new target cell DTX configuration 220 even if the target network device can transmit the new target cell DTX configuration 220 to the source network device for CHO.

The target network device may assume the UE is applying the old target cell DTX configuration 210 while the UE is actually applying the new target cell DTX configuration 220.

The target network device may assume the UE is applying the new target cell DTX configuration 220 while the UE is actually applying the old target cell DTX configuration 210. In this case, the UE may monitor the PDCCH occasions 234 and 236 based on the old target cell DTX configuration 210. However, the target network device may transmit downlink transmission on the PDCCH occasion 232. Thus, it may introduce unnecessary UE consumption and failed PDCCH transmission.

All of the transmission may fail if there is no overlapped active duration between the old target cell DTX configuration 210 and the new target cell DTX configuration 220.

In view of the above, it needs to discuss how to obtain the updated configuration for the target cell after accessing to the target cell.

On the other hand, the new target cell DRX configuration may be misaligned with information for the target cell which was received after starting synchronization with the target cell is started. This will be described with reference to FIG. 2C.

FIG. 2C illustrates an example of cell DRX configurations for a target cell and UE behavior. In the example of FIG. 2C, the UE assumes that a cell DRX configuration for a target cell is the cell DRX configuration 250 and applies the cell DRX configuration 250. However, the target network device actually applies a cell DRX configuration 240 for the target cell.

The UE starts the synchronization with the target cell by performing a contention-free random access (CFRA) procedure with 4-step RA type. An RA response (i.e., MSG2) comprises information for the target cell. For example, the RA response may comprise an uplink (UL) grant 260 allocated to the UE. The UL grant 260 indicates an UL resource 262 which overlaps with a cell DRX non-active period 264. Thus, the UL grant 260 is misaligned with the cell DRX configuration 250. Alternatively, the UE may start the synchronization with the target cell by performing a contention-based random access (CBRA) procedure.

From the perspective of power saving on the side of the target network device, the target network device does not receive the UL transmission during cell DRX non-active periods and the target network device schedules the retransmission during cell DRX active periods. Considering the potential failure PDCCH reception because of the potential misalignment between the cell DTX configuration 250 and the UL grant 260, a large latency may be introduced.

From the perspective of UE, the UE may identify the misalignment between the cell DTX configuration 250 and the UL grant 260 before the target network device identifies the problem due to the allocated “unavailable” UL grant 260, if the UE cannot transmit on the resource 262 indicated by the UL grant 260 during cell DRX non-active periods.

Embodiments of the present disclosure provide a solution for communications. In the solution, a terminal device performs a handover to a first cell provided by a first network device. In turn, the terminal device receives, from the first network device, downlink transmission in the first cell.

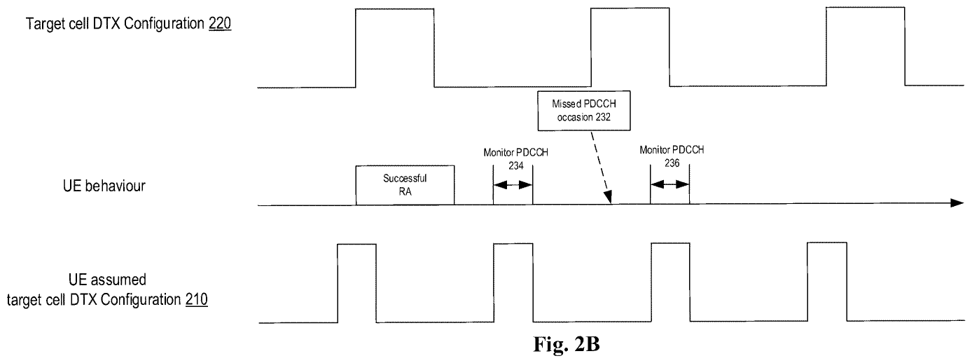

Hereinafter, principle of the present disclosure will be described with reference to FIGS. 3 to 13.

FIG. 3 illustrates a signaling chart illustrating an example process 300 for communications in accordance with some embodiments of the present disclosure. For the purpose of discussion, the process 300 will be described with reference to FIG. 1A or 1B. The process 300 may involve the terminal device 130 and the first network device 110.

As shown in FIG. 3, the terminal device 130 performs 310 a handover to the first cell 112 provided by the first network device 110.

In some embodiments, the handover may be triggered by a source network device via a handover command, such as the second network device 120 (in the example of FIG. 1A) or by the first network device 110 (in the example of FIG. 1B).

Alternatively, in some embodiments, the handover may be CHO.

In some embodiments, the first cell 112 may be one of at least one candidate cell.

In turn, the terminal device 130 receives 320, from the first network device 110, downlink transmission in the first cell 112.

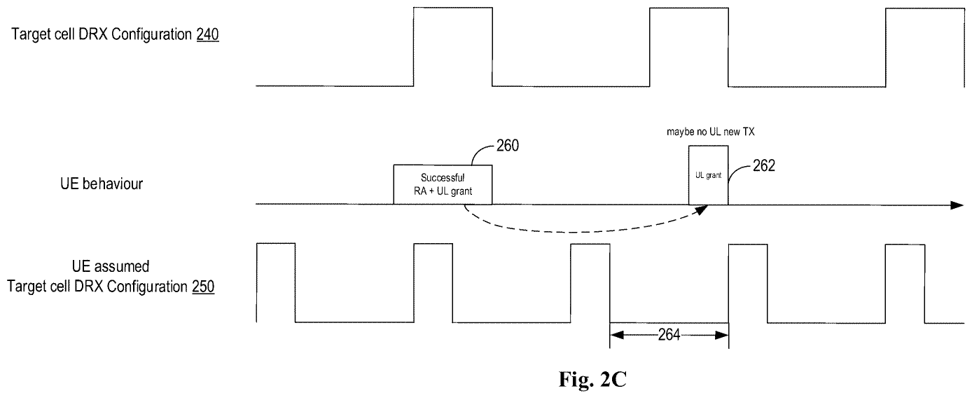

Hereinafter, some embodiments of the present disclosure will be described with reference to FIGS. 4 to 10.

FIG. 4 illustrates a signaling chart illustrating an example process 400 for communications in accordance with some embodiments of the present disclosure. The process 400 may be considered as an example implementation of the process 300. For the purpose of discussion, the process 400 will be described with reference to FIG. 1A or 1B. The process 400 may involve the terminal device 130 and the first network device 110.

As shown in FIG. 4, the terminal device 130 may perform 410 a handover to the first cell 112 by performing an RA procedure to the first cell 112.

After successfully completing the RA procedure to the first cell 112, the terminal device 130 may keep on monitoring 420 a downlink control channel for a time duration.

In some embodiments, the terminal device 130 may receive 430 a first configuration related to NES for the first cell 112 by keeping on monitoring the downlink control channel for the time duration.

In some embodiments, the first configuration related to NES for the first cell 112 may comprise at least one of the following: a cell DRX configuration for the first cell 112, a cell DTX configuration for the first cell 112, an uplink grant or a downlink resource.

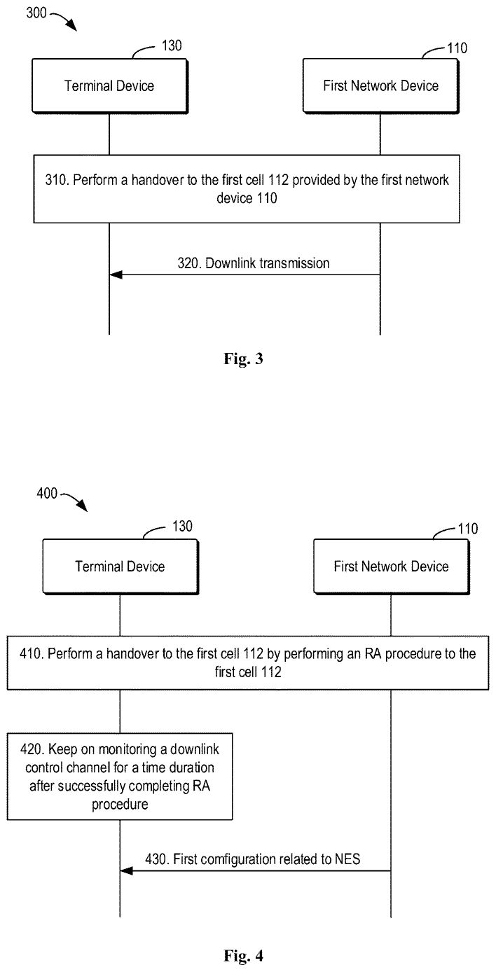

In some embodiments, the downlink control channel may comprise a PDCCH. This will be described with reference to FIG. 5.

FIG. 5 illustrates an example of cell DTX configurations for the first cell 112 and behavior of the terminal device 130. In the example of FIG. 5, the terminal device 130 may perform a handover to the first cell 112 by performing an RA procedure to the first cell 112. After the handover to the first cell 112 is started, the terminal device 130 may receive second information for the first cell 112 from the first network device 110. For example, the second information for the first cell 112 may comprise at least one of the following: a cell DRX configuration for the first cell 112, a cell DTX configuration 510 for the first cell 112 as shown in FIG. 5, an uplink grant or a downlink resource. Hereinafter, the example of FIG. 5 will be described by taking the cell DTX configuration 510 as an example of the second information.

In turn, the terminal device 130 may assume that a cell DTX configuration for the target cell 112 is the cell DTX configuration 510. However, the first network device 110 may actually apply a cell DTX configuration 520 for the first cell 112. The cell DTX configuration 520 is different from or misaligned with the cell DTX configuration 510. For example, each of active periods 522, 524 and 526 of the cell DTX configuration 520 is misaligned with each of active periods 512, 514, 516 and 518 of the cell DTX configuration 510.

Hereinafter, the cell DTX configuration 520 is also referred to as a new or updated cell DTX configuration 520, and the cell DTX configuration 510 is also referred to as an old cell DTX configuration 510.

With continued reference to FIG. 5, the terminal device 130 successfully completes the RA procedure to the first cell 112 at time 530. After successfully completing the RA procedure at time 530, the terminal device 130 keeps on monitoring DL (i.e., PDCCH) for a time duration 532. In this way, if the first network device 110 performs downlink transmission to the terminal device 130 during the time duration 532, the terminal device 130 will not miss the downlink transmission.

In some embodiments, the second network device 120 may determine the time duration 532 and transmit a configuration for the time duration 532 to the first network device 110. Alternatively, the first network device 110 may determine the time duration 532 and transmit a configuration for the time duration 532 to the second network device 120.

In some embodiments, the terminal device 130 may receive a configuration for the time duration 532 from the first network device 110 or the second network device 120. Alternatively, the time duration 532 may be pre-defined.

In some embodiments, the time duration 532 may be defined by a timer.

In some embodiments, the terminal device 130 may start the timer when successfully completing the RA procedure at time 530.

In some embodiments, the first network device 110 may transmit, to the terminal device 130, an indication of the updated cell DTX configuration 520 after the RA procedure. For example, the first network device 110 may transmit, to the terminal device 130, the indication of the updated cell DTX configuration 520 during the time duration 532. For example, the first network device 110 may transmit an RRCReconfiguration message to the terminal device 130. The RRCReconfiguration message may comprise the indication of the old cell DTX configuration 510.

In some embodiments, the first network device 110 may transmit the indication of the old cell DTX configuration 510 before transmitting the indication of the updated cell DTX configuration 520.

In some embodiments, the terminal device 130 may stop the timer when the updated cell DTX configuration 520 is received.

In some embodiments, if the updated cell DTX configuration 520 is not received or the updated cell DTX configuration 520 is the same as the old cell DTX configuration 510 when the timer expiry, the terminal device 130 may communicate with the first network device 110 based on the old cell DTX configuration 510.

It shall be noted that although the example of FIG. 5 has been described by taking the cell DTX configurations as examples of the first configuration related to NES and the second information, the cell DRX configurations are also applied to the present disclosure.

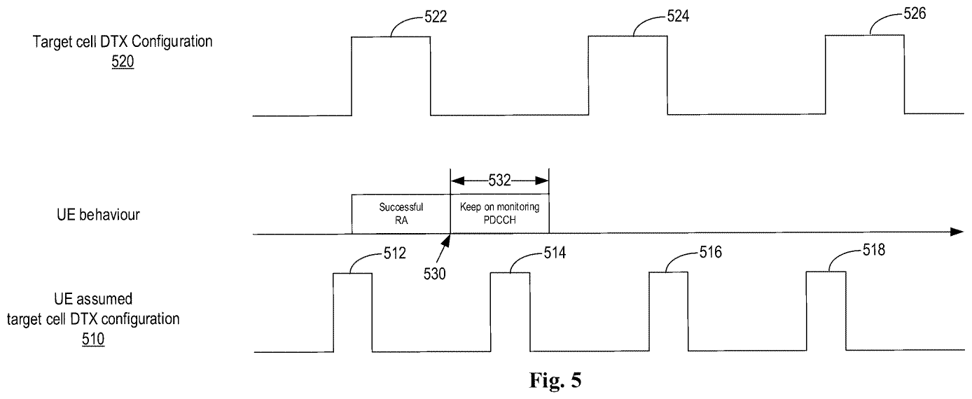

In some embodiments, the first network device 110 may transmit the first configuration related to NES for the first cell 112 during an RA procedure to the first cell 112. This will be described with reference to FIG. 6.

FIG. 6 illustrates a signaling chart illustrating an example process 600 for communications in accordance with some embodiments of the present disclosure. The process 600 may be considered as another example implementation of the process 300. For the purpose of discussion, the process 600 will be described with reference to FIG. 1A or 1B. The process 600 may involve the terminal device 130 and the first network device 110.

As shown in FIG. 6, the terminal device 130 may perform a handover to the first cell 112 by performing a CFRA procedure with 4-step RA type.

Specifically, the first network device 110 assigns 605 a dedicated RA preamble to the terminal device 130.

The terminal device 130 transmits 610 the dedicated RA Preamble to the first network device 110 on a physical random access channel (PRACH).

Upon receiving the dedicated RA preamble, the first network device 110 can identify the terminal device 130. In turn, the first network device 110 transmits 620 an RA response. The RA response may comprise a first indication of the first configuration related to NES for the first cell 112. For example, a new format for the RA response may be designed to include the first indication.

In some embodiments, the first indication of the first configuration related to NES for the first cell 112 may indicate at least one of the following: activation or deactivation of the first configuration, the first configuration or an index of the first configuration.

In some embodiments, the RA response may comprise at least one medium access control (MAC) subheader comprising the first indication. For example, a first MAC subheader may comprise an indication of the activation or deactivation of the first configuration, a second MAC subheader may comprise an indication of the first configuration and/or a third MAC subheader may comprise an indication of the index of the first configuration.

Upon receiving the RA response from the first network device 110, the terminal device 130 ends the RA procedure.

Alternatively, in some embodiments, the terminal device 130 may perform a handover to the first cell 112 by performing a contention-based random access (CBRA) procedure with 4-step RA type. In such embodiments, the first network device 110 transmits a contention resolution message (MSG4) to the terminal device 130. The contention resolution message may comprise the first indication of the first configuration.

In embodiments where the CBRA procedure with 4-step RA type is performed, the RA response may comprise an indication whether the first configuration is different from or misaligned with the second information. For example, the first configuration may comprise the updated cell DTX configuration 520 and the second information may comprise the old cell DTX configuration 510 as shown in FIG. 5. The RA response may comprise an indication that the updated cell DTX configuration 520 is different from or misaligned with the old cell DTX configuration 510. The contention resolution message may comprise the first indication of the updated cell DTX configuration 520.

Alternatively, in some embodiments, the terminal device 130 may perform a handover to the first cell 112 by performing a contention-based random access (CBRA) procedure with 2-step RA type or CFRA procedure with 2-step RA type. In such embodiments, the first network device 110 transmits a contention resolution message or RA response (MSGB) to the terminal device 130. The MSGB may comprise the first indication of the first configuration.

FIG. 7 illustrates a signaling chart illustrating an example process 700 for communications in accordance with some embodiments of the present disclosure. The process 700 may be considered as another example implementation of the process 300. For the purpose of discussion, the process 700 will be described with reference to FIG. 1A or 1B. The process 700 may involve the terminal device 130 and the first network device 110.

As shown in FIG. 7, the first network device 110 determines 710 potential downlink occasions based on the first configuration related to NES for the first cell 112 and the second information for the first cell 112.

In turn, the first network device 110 performs 720 downlink transmission to the first network device 110 on at least one of the potential downlink occasions.

In some embodiments, the first network device 110 may transmit, to the terminal device 130, the first configuration related to NES for the first cell 112 on at least one of the potential downlink occasions.

For example, as shown in FIG. 5, the first configuration may comprise the updated cell DTX configuration 520 and the second information may comprise the old cell DTX configuration 510. Based on the updated cell DTX configuration 520 and the old cell DTX configuration 510, the first network device 110 determines potential downlink occasions 514, 516, 518, 524 and 526. The first network device 110 may perform downlink transmission to the first network device 110 on at least one of the potential downlink occasions 514, 516, 518, 524 and 526. For example, the first network device 110 may transmit, to the terminal device 130, the updated cell DTX configuration 520 on at least one of the potential downlink occasions 514, 516, 518, 524 and 526. Until the updated cell DTX configuration 520 is received by the terminal device 130, the first network device 110 may stop the downlink transmission.

FIG. 8 illustrates a signaling chart illustrating an example process 800 for communications in accordance with some embodiments of the present disclosure. The process 800 may be considered as another example implementation of the process 300. For the purpose of discussion, the process 800 will be described with reference to FIG. 1A or 1B. The process 800 may involve the terminal device 130 and the first network device 110.

As shown in FIG. 8, the first network device 110 determines 810 potential uplink occasions based on the first configuration related to NES for the first cell 112 and the second information for the first cell 112.

In turn, the first network device 110 receives 820 uplink transmission from the terminal device 130 on at least one of the potential uplink occasions.

In some embodiments, the first network device 110 may receive, from the terminal device 130, information about the NES for the first cell 112 on at least one of the potential uplink occasions.

In some embodiments, the information about the NES for the first cell 112 comprises at least one of the following:
a second indication that the second information is misaligned with the first configuration,
a third indication that the second information is aligned with the first configuration,
a request for the first configuration, or
a fourth indication of the second information.

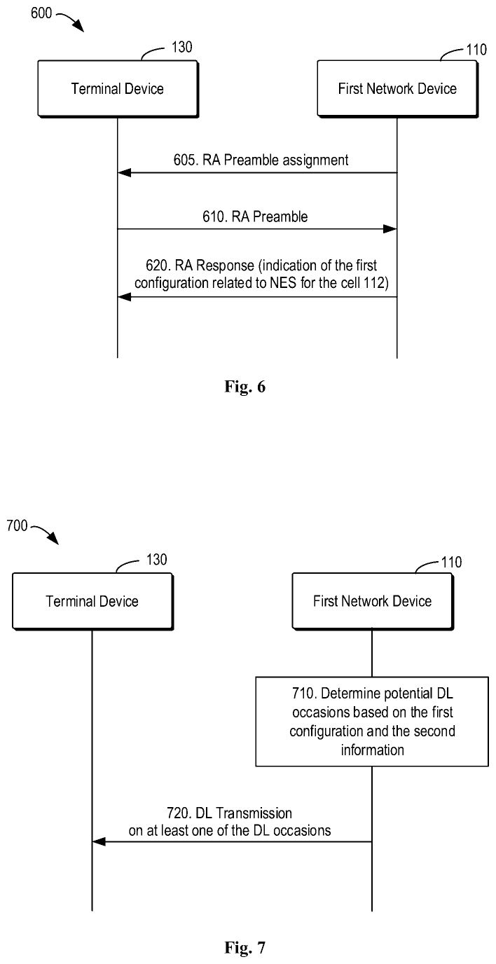

Consider an example which is illustrated in FIG. 9. FIG. 9 illustrates an example of cell DRX configurations for the first cell 112 (i.e., the target cell) and behavior of the terminal device 130. In the example of FIG. 9, the terminal device 130 assumes that a cell DRX configuration for the first cell 112 is a cell DRX configuration 910 and applies the cell DRX configuration 910. However, the target network device actually applies a cell DRX configuration 920 for the first cell 112.

The terminal device 130 may perform the handover to the first cell 112 by performing a CFRA or CBFA procedure with 4-step RA type. Alternatively, the terminal device 130 may perform the handover to the first cell 112 by performing a CFRA or CBFA procedure with 2-step RA type.

A MSG2 or MSG4 in the CFRA or CBFA procedure with 4-step RA type or MSGB in the CFRA or CBFA procedure with 2-step RA type may comprise a UL grant 930 allocated to the terminal device 130.

Alternatively, in some embodiments, the terminal device 130 may obtain the UL grant 930 from a dynamic scheduling.

The UL grant 930 indicates an UL resource 932. The UL resource 932 overlaps with a cell DRX non-active period 934. In other words, the UL resource 932 is misaligned with cell DRX active periods 912, 914, 916 and 918 of the cell DRX configuration 910. Thus, the UL grant 930 is misaligned with the cell DRX configuration 910.

The first network device 110 determines potential uplink occasions 922, 924, 926 and 932 based on the cell DRX configuration 920 and the UL grant 930. In turn, the first network device 110 receives uplink transmission from the terminal device 130 on at least one of the potential uplink occasions 922, 924, 926 and 932. Thus, the first network device 110 will not miss the uplink transmission on at least one of the potential uplink occasions 922, 924, 926 and 932. In this way, latency of the uplink transmission will be reduced.

For example, the first network device 110 may receive, from the terminal device 130, the information about the NES for the first cell 112 on at least one of the potential uplink occasions 922, 924, 926 and 932.

From the perspective of the terminal device 130, the terminal device 130 may identify the misalignment between the cell DRX configuration 910 and the UL grant 930. Thus, the terminal device 130 may transmit the information about the NES for the first cell 112 on the uplink occasion 932.

In some embodiments, the terminal device 130 may transmit UE assistance information to the first network device 110. The UE assistance information comprises the information about the NES for the first cell 112.

For example, the information about the NES for the first cell 112 may comprise an indication that the cell DRX configuration 910 is misaligned with the UL grant 930 (i.e., the second indication that the second information is misaligned with the first configuration).

For another example, the information about the NES for the first cell 112 may comprise a request for the cell DRX configuration 920. Alternatively, the information about the NES for the first cell 112 may comprise an indication of the cell DRX configuration 910.

Upon receiving the information about the NES for the first cell 112 from the terminal device 130, the first network device 110 may transmit the cell DRX configuration 920 to the terminal device 130. Until the cell DRX configuration 920 is received by the terminal device 130, the first network device 110 may communicate with the terminal device 130 based on the cell DRX configuration 920.

It shall be understood that although the example of FIG. 9 has been described by taking the cell DRX configurations as an example, cell DTX configurations are also applied to the present disclosure.

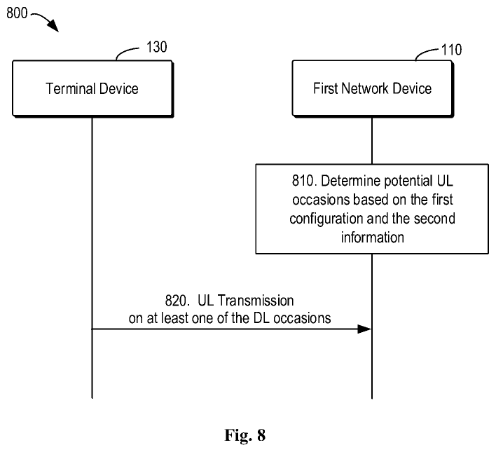

Alternatively, in some embodiments, an RA procedure is not restricted by the NES related configuration. In such embodiments, the terminal device 130 may transmit the information about the NES for the first cell 112 by transmitting an uplink message associated with an RA procedure to the first cell 112. This will be described with reference to FIGS. 9 and 10.

FIG. 10 illustrates a signaling chart illustrating an example process 1000 for communications in accordance with some embodiments of the present disclosure. The process 1000 may be considered as another example implementation of the process 300. For the purpose of discussion, the process 1000 will be described with reference to FIG. 1A or 1B. The process 1000 may involve the terminal device 130 and the first network device 110.

In the example of FIG. 10, the terminal device 130 may transmit the information about the NES for the first cell 112 by performing a CBRA procedure with 4-step RA type. Before performing the CBRA procedure with 4-step RA type, the terminal device 130 may obtain a UL grant (such as the UL grant 930 in FIG. 9).

For example, as described with reference to FIG. 9, the terminal device 130 may obtain the UL grant 930 from a MSG2 or MSG4 in a previous CFRA or CBFA procedure with 4-step RA type or MSGB in a previous CFRA or CBFA procedure with 2-step RA type. Alternatively, the terminal device 130 may obtain the UL grant 930 from a dynamic scheduling.

In some embodiments, the CBRA procedure as shown in FIG. 10 may be triggered by an event that the second information is misaligned with the first configuration related to NES for the first cell 112. For example, the CBRA procedure as shown in FIG. 10 may be triggered by an event that the UL grant 930 is misaligned with the cell DRX configuration 910.

The terminal device 130 transmits 1010 an RA preamble (MSG1) to the first network device 110 on a PRACH. The RA preamble may indicate the information about the NES for the first cell 112.

For example, the information about the NES for the first cell 112 may comprise an indication that the cell DRX configuration 910 is misaligned with the UL grant 930 (i.e., the second indication that the second information is misaligned with the first configuration).

For another example, the information about the NES for the first cell 112 may comprise a request for the cell DTX configuration 920. Alternatively, the information about the NES for the first cell 112 may comprise an indication of the cell DRX configuration 910.

In some embodiments, the first network device 110 may associate a set of dedicated RACH resources with feature(s) applicable to a Random Access procedure. For example, the first network device 110 may associate a set of dedicated RACH resources with NES configuration for a cell. Transmission of the RA preamble on the set of dedicated RACH resources may indicate the information about the NES for the first cell 112.

Upon receiving the RA preamble, the first network device 110 transmits 1020 an RA response.

Upon reception of the RA response, the terminal device 130 transmits 1030 a scheduled transmission (MSG3) using a UL grant scheduled in the RA response and monitors a contention resolution message (MSG4).

Alternatively, in some embodiments, the MSG3 may comprise the information about the NES for the first cell 112. For example, a new MAC control element (CE) and/or logical channel identifier (LCID) or a new RRC message may be included in the MSG3 to carry the information about the NES for the first cell 112.

In turn, the first network device 110 transmits 1040 a contention resolution message to the terminal device 130. The contention resolution message may comprise the first indication of the first configuration related to NES for the first cell 112. Alternatively, the first network device 110 may transmit the first indication of the first configuration after the contention resolution message. The first indication of the first configuration may indicate the activation or deactivation of the first configuration, an index of the first configuration or the first configuration.

Once the first indication of the first configuration is received, the RA procedure is considered to be successfully completed.

Alternatively, in some embodiments, the terminal device 130 may transmit the information about the NES for the first cell 112 by performing a CBRA procedure with 2-step RA type or CFRA procedure with 2-step RA type. In such embodiments, the terminal device 130 transmits a MSGA to the first network device 110. The MSGA may comprise the information about the NES for the first cell 112.

Alternatively, in some embodiments, the terminal device 130 may transmit the information about the NES for the first cell 112 by performing a CBRA procedure with 2-step RA type or CFRA procedure with 2-step RA type. In such embodiments, the terminal device 130 transmits a MSGA to the first network device 110. The MSGA may indicate the information about the NES for the first cell 112.

Alternatively, in some embodiments, the terminal device 130 may transmit the information about the NES for the first cell 112 by performing a CFRA procedure with 4-step RA type. In such embodiments, the terminal device 130 transmits a MSG1 to the first network device 110. The MSG1 or MSG3 may indicate the information about the NES for the first cell 112.

Alternatively, in some embodiments, a PUCCH transmission (i.e. scheduling request (SR)) or a PUSCH transmission (i.e. configured grant transmission) is not restricted by the NES related configuration. In such embodiments, the terminal device 130 may transmit the SR to the first network device 110. Upon receiving the SR, the first network device 110 may transmit a further UL grant to the terminal device 130. The terminal device 130 may transmit an uplink message on a resource indicated by the further UL grant. The uplink message may comprise the information about the NES for the first cell 112.

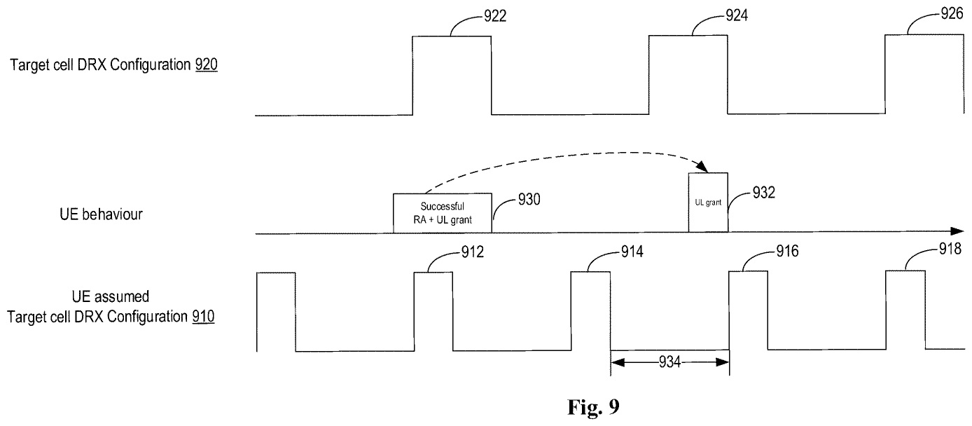

FIG. 11 illustrates a flowchart of a method 1100 implemented at a terminal device in accordance with some embodiments of the present disclosure. For the purpose of discussion, the method 1100 will be described from the perspective of the terminal device 130 with reference to FIG. 1A or 1B.

At block 1110, the terminal device 130 performs a handover to a first cell provided by the first network device 110.

At block 1120, the terminal device 130 receives, from the first network device 110, downlink transmission in the first cell.

In some embodiments, receiving the downlink transmission comprises keeping on monitoring a downlink control channel for a time duration after successfully completing a random access procedure to the first cell.

In some embodiments, receiving the downlink transmission comprises receiving a first configuration related to network energy saving for the first cell during a random access procedure to the first cell or after the random access procedure; and the method 1100 further comprises: communicating with the first network device based on the first configuration.

In some embodiments, receiving the first configuration comprises receiving the first configuration by keeping on monitoring a downlink control channel for a time duration after successfully completing the random access procedure.

In some embodiments, the method 1100 further comprises: receiving a configuration for the time duration from the first network device or a second network device, the second network device providing a source cell for the terminal device.

In some embodiments, the time duration is defined by a timer.

In some embodiments, the method 1100 further comprises: starting the timer when successfully completing the random access procedure.

In some embodiments, the method 1100 further comprises: stopping the timer when the first configuration is received.

In some embodiments, receiving the first configuration comprises: receiving at least one downlink message associated with the random access procedure, the at least one downlink message comprising a first indication of the first configuration.

In some embodiments, the first indication indicates at least one of the following: activation or deactivation of the first configuration, the first configuration, or an index of the first configuration.

In some embodiments, the at least one downlink message comprises at least one medium access control subheader comprising the first indication.

In some embodiments, the method 1100 further comprises: after the handover to the first cell is started, receiving second information for the first cell from the first network device.

In some embodiments, each of the first configuration and the second information comprises at least one of the following: a cell discontinuous reception configuration, a cell discontinuous transmission configuration, an uplink grant, or a downlink resource.

In some embodiments, the method 1100 further comprises: before receiving the first configuration, transmitting information about the network energy saving for the first cell to the first network device.

In some embodiments, the information about the network energy saving for the first cell comprises at least one of the following: a second indication that the second information is misaligned with the first configuration, a third indication that the second information is aligned with the first configuration, a request for the first configuration, or a fourth indication of the second information.

In some embodiments, transmitting the information about the network energy saving for the first cell comprises: transmitting the information about the network energy saving for the first cell on a set of dedicated physical random access channel resources.

In some embodiments, transmitting the information about the network energy saving for the first cell comprises: transmitting an uplink message to the first network device, the uplink message comprising the information about the network energy saving for the first cell, the uplink message being associated with a random access procedure to the first cell or associated with a scheduling request.

In some embodiments, the random access procedure is triggered by an event that the second information is misaligned with the first configuration.

In some embodiments, transmitting the information about the network energy saving for the first cell comprises: transmitting user equipment (UE) assistance information via the transceiver to the first network device, the UE assistance information comprising the information about the network energy saving for the first cell.

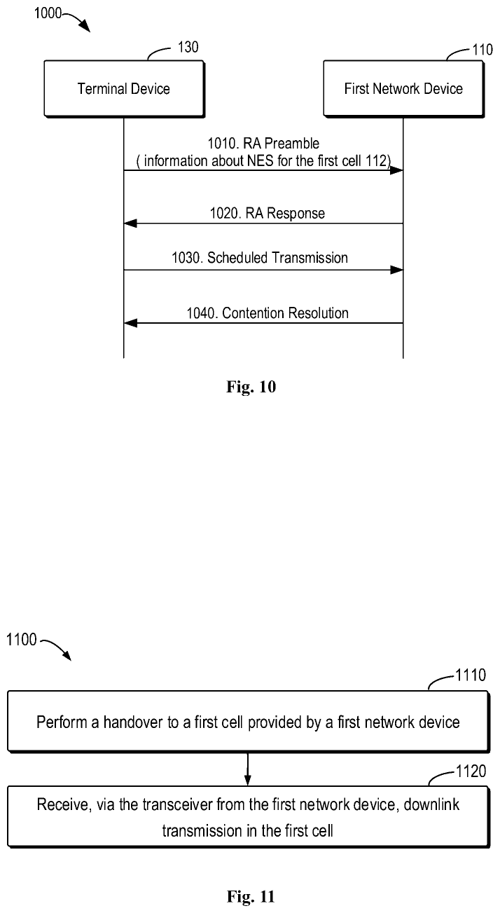

FIG. 12 illustrates a flowchart of a method 1200 implemented at a network device in accordance with some embodiments of the present disclosure. For the purpose of discussion, the method 1200 will be described from the perspective of the first network device 110 with reference to FIG. 1A or 1B.

At block 1210, the first network device 110 transmits, to the terminal device 130 which performs a handover to a first cell provided by the first network device 110, a first configuration related to network energy saving for the first cell.

At block 1220, the first network device 110 communicates with the terminal device 130 based on the first configuration.

In some embodiments, transmitting the first configuration comprises transmitting the first configuration during a random access procedure of the terminal device to the first cell or after the random access procedure.

In some embodiments, the method 1200 further comprises: transmitting, to a second network device, a configuration for a time duration, the second network device providing a source cell for the terminal device, the terminal device keeping on monitoring a downlink control channel for the time duration after successfully completing the random access procedure.

In some embodiments, the time duration is defined by a timer.

In some embodiments, transmitting the first configuration comprises: transmitting at least one downlink message associated with the random access procedure, the at least one downlink message comprising a first indication of the first configuration.

In some embodiments, the first indication indicates at least one of the following: activation or deactivation of the first configuration, the first configuration, or an index of the first configuration.

In some embodiments, the at least one downlink message comprises at least one medium access control subheader comprising the first indication.

In some embodiments, the method 1200 further comprises: transmitting, to the terminal device, second information for the first cell after the handover is started.

In some embodiments, each of the first configuration and the second information comprises at least one of the following: a cell discontinuous reception configuration, a cell discontinuous transmission configuration, an uplink grant, or a downlink resource.

In some embodiments, the method 1200 further comprises: before transmitting the first configuration, receiving information about the network energy saving for the first cell from the terminal device.

In some embodiments, the information about the network energy saving for the first cell comprises at least one of the following: a second indication that the second information is misaligned with the first configuration, a third indication that the second information is aligned with the first configuration, a request for the first configuration, or a fourth indication of the second information.

In some embodiments, receiving the information about the network energy saving for the first cell comprises: receiving the information about the network energy saving for the first cell on a set of dedicated physical random access channel resources.

In some embodiments, receiving the information about the network energy saving for the first cell comprises: receiving an uplink message from the terminal device, the uplink message comprising the information about the network energy saving for the first cell, the uplink message being associated with a random access procedure of the terminal device to the first cell or associated with a scheduling request.

In some embodiments, receiving the information about the network energy saving for the first cell comprises: receiving user equipment (UE) assistance information from the terminal device, the UE assistance information comprising the information about the network energy saving for the first cell.

In some embodiments, the method 1200 further comprises: determining potential downlink occasions based on the first configuration and the second information; and transmitting the first configuration comprises: transmitting the first configuration on at least one of the downlink occasions.

In some embodiments, the method 1200 further comprises: determining potential uplink occasions based on the first configuration and the second information; and receiving, from the terminal device, uplink transmission on at least one of the uplink occasions.

In some embodiments, the uplink transmission comprises information about the network energy saving for the first cell.

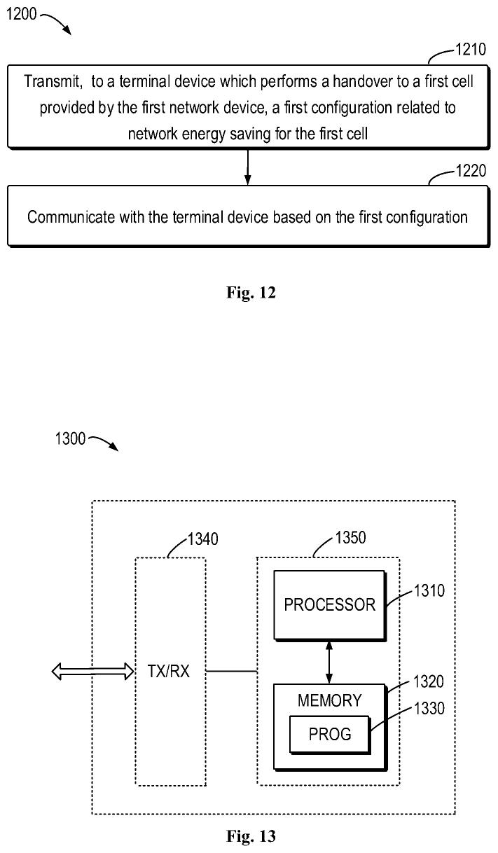

FIG. 13 illustrates a simplified block diagram of an apparatus 1300 that is suitable for implementing embodiments of the present disclosure. The apparatus 1300 can be considered as a further example implementation of the terminal device 130 or the network device 110 as shown in FIGS. 1A and 1B. Accordingly, the apparatus 1300 can be implemented at or as at least a part of the terminal device 130 or the network device 110.

As shown, the apparatus 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1330 is assumed to include program instructions that, when executed by the associated processor 1310, enable the apparatus 1300 to operate in accordance with the embodiments of the present disclosure, as discussed herein with reference to FIGS. 1A to 12. The embodiments herein may be implemented by computer software executable by the processor 1310 of the apparatus 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1320 is shown in the apparatus 1300, there may be several physically distinct memory modules in the apparatus 1300. The processor 1310 may be of any type suitable to the local technical network, and may include one or more of general purpose computers, special purpose computers, microprocessors, digital signal processors (DSPs) and processors based on multicore processor architecture, as non-limiting examples. The apparatus 1300 may have multiple processors, such as an application specific integrated circuit chip that is slaved in time to a clock which synchronizes the main processor.

In summary, embodiments of the present disclosure provide the following solutions.

Clause 1. A terminal device, comprising a processor; and a transceiver coupled to the processor, wherein the processor is configured to: perform a handover to a first cell provided by a first network device; and receive, via the transceiver from the first network device, downlink transmission in the first cell.

Clause 2. The terminal device of clause 1, wherein the terminal device is caused to receive the downlink transmission by keeping on monitoring a downlink control channel for a time duration after successfully completing a random access procedure to the first cell.

Clause 3. The terminal device of clause 1, wherein the terminal device is caused to receive the downlink transmission by receiving a first configuration related to network energy saving for the first cell during a random access procedure to the first cell or after the random access procedure; and the terminal device is further caused to communicate with the first network device based on the first configuration.

Clause 4. The terminal device of clause 3, wherein the terminal device is caused to receive the first configuration by keeping on monitoring a downlink control channel for a time duration after successfully completing the random access procedure.

Clause 5. The terminal device of clause 2 or 4, wherein the terminal device is further caused to receive a configuration for the time duration via the transceiver from the first network device or a second network device, the second network device providing a source cell for the terminal device.

Clause 6. The terminal device of clause 2 or 4, wherein the time duration is defined by a timer.

Clause 7. The terminal device of clause 6, wherein the terminal device is further caused to start the timer when successfully completing the random access procedure.

Clause 8. The terminal device of clause 6, wherein the terminal device is further caused to stop the timer when the first configuration is received.

Clause 9. The terminal device of clause 3, wherein the terminal device is caused to receive the first configuration by receiving at least one downlink message associated with the random access procedure, the at least one downlink message comprising a first indication of the first configuration.

Clause 10. The terminal device of clause 9, wherein the first indication indicates at least one of the following: activation or deactivation of the first configuration, the first configuration, or an index of the first configuration.

Clause 11. The terminal device of clause 9, wherein the at least one downlink message comprises at least one medium access control subheader comprising the first indication.

Clause 12. The terminal device of clause 1, wherein the terminal device is further caused to: after the handover to the first cell is started, receive second information for the first cell via the transceiver from the first network device.

Clause 13. The terminal device of clause 12, wherein each of the first configuration and the second information comprises at least one of the following: a cell discontinuous reception configuration, a cell discontinuous transmission configuration, an uplink grant, or a downlink resource.

Clause 14. The terminal device of clause 12, wherein the terminal device is further caused to: before receiving the first configuration, transmit information about the network energy saving for the first cell via the transceiver to the first network device.

Clause 15. The terminal device of clause 14, wherein the information about the network energy saving for the first cell comprises at least one of the following: a second indication that the second information is misaligned with the first configuration, a third indication that the second information is aligned with the first configuration, a request for the first configuration, or a fourth indication of the second information.

Clause 16. The terminal device of clause 14, wherein the terminal device is caused to transmit the information about the network energy saving for the first cell by transmitting the information about the network energy saving for the first cell on a set of dedicated physical random access channel resources.

Clause 17. The terminal device of clause 14, wherein the terminal device is caused to transmit the information about the network energy saving for the first cell by transmitting an uplink message via the transceiver to the first network device, the uplink message comprising the information about the network energy saving for the first cell, the uplink message being associated with a random access procedure to the first cell or associated with a scheduling request.

Clause 18. The terminal device of clause 17, wherein the random access procedure is triggered by an event that the second information is misaligned with the first configuration.

Clause 19. The terminal device of clause 14, wherein the terminal device is caused to transmit the information about the network energy saving for the first cell by transmitting user equipment (UE) assistance information via the transceiver to the first network device, the UE assistance information comprising the information about the network energy saving for the first cell.

Clause 20. A first network device, comprising a processor; and a transceiver coupled to the processor, wherein the processor is configured to: transmit, via the transceiver to a terminal device which performs a handover to a first cell provided by the first network device, a first configuration related to network energy saving for the first cell; and communicate with the terminal device based on the first configuration.

Clause 21. The first network device of clause 20, wherein the first network device is caused to transmit the first configuration during a random access procedure of the terminal device to the first cell or after the random access procedure.

Clause 22. The first network device of clause 21, wherein the first network device is further caused to: transmit, the transceiver to a second network device, a configuration for a time duration, the second network device providing a source cell for the terminal device, the terminal device keeping on monitoring a downlink control channel for the time duration after successfully completing the random access procedure.

Clause 23. The first network device of clause 22, wherein the time duration is defined by a timer.

Clause 24. The first network device of clause 21, wherein the first network device is caused to transmit the first configuration by transmitting at least one downlink message associated with the random access procedure, the at least one downlink message comprising a first indication of the first configuration.

Clause 25. The first network device of clause 24, wherein the first indication indicates at least one of the following: activation or deactivation of the first configuration, the first configuration, or an index of the first configuration.

Clause 26. The first network device of clause 24, wherein the at least one downlink message comprises at least one medium access control subheader comprising the first indication.

Clause 27. The first network device of clause 20, wherein the first network device is further caused to transmit, via the transceiver to the terminal device, second information for the first cell after the handover is started.

Clause 28. The terminal device of clause 27, wherein each of the first configuration and the second information comprises at least one of the following: a cell discontinuous reception configuration, a cell discontinuous transmission configuration, an uplink grant, or a downlink resource.

Clause 29. The first network device of clause 27, wherein the first network device is further caused to: before transmitting the first configuration, receiving information about the network energy saving for the first cell via the transceiver from the terminal device.

Clause 30. The first network device of clause 29, wherein the information about the network energy saving for the first cell comprises at least one of the following: a second indication that the second information is misaligned with the first configuration, a third indication that the second information is aligned with the first configuration, a request for the first configuration, or a fourth indication of the second information.

Clause 31. The first network device of clause 29, wherein the first network device is caused to receive the information about the network energy saving for the first cell by receiving the information about the network energy saving for the first cell on a set of dedicated physical random access channel resources.

Clause 32. The first network device of clause 29, wherein the first network device is caused to receive the information about the network energy saving for the first cell by receiving an uplink message via the transceiver from the terminal device, the uplink message comprising the information about the network energy saving for the first cell, the uplink message being associated with a random access procedure of the terminal device to the first cell or associated with a scheduling request.

Clause 33. The first network device of clause 29, wherein the first network device is caused to receive the information about the network energy saving for the first cell by receiving user equipment (UE) assistance information via the transceiver from the terminal device, the UE assistance information comprising the information about the network energy saving for the first cell.

Clause 34. The first network device of clause 27, wherein the first network device is further caused to determine potential downlink occasions based on the first configuration and the second information; and the first network device is caused to transmit the first configuration by transmit the first configuration on at least one of the downlink occasions.

Clause 35. The first network device of clause 27, wherein the first network device is further caused to: determine potential uplink occasions based on the first configuration and the second information; and receive, via the transceiver from the terminal device, uplink transmission on at least one of the uplink occasions.

Clause 36. The first network device of clause 35, wherein the uplink transmission comprises information about the network energy saving for the first cell.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A user equipment (UE), comprising:
at least one memory; and
at least one processor coupled with the at least one memory and configured to cause the UE to:
perform a handover to a first cell provided by a first network equipment (NE); and
receive, from the first NE, downlink transmission in the first cell.

2. The UE of claim 1, wherein the at least one processor is configured to cause the UE to receive the downlink transmission by:
monitoring a downlink control channel for a time duration after successfully completing a random access procedure to the first cell.

3. The UE of claim 1, wherein the at least one processor is configured to cause the UE to receive the downlink transmission by:
receiving a first configuration related to network energy saving for the first cell during a random access procedure to the first cell or after the random access procedure; and
communicate with the first NE based on the first configuration.

4. The UE of claim 3, wherein the at least one processor is configured to cause the UE to receive the first configuration by:
monitoring a downlink control channel for a time duration after successfully completing the random access procedure.

5. The UE of claim 3, wherein the at least one processor is configured to cause the UE to receive the first configuration by:
receiving at least one downlink message associated with the random access procedure, wherein the at least one downlink message comprises a first indication of the first configuration.

6. The UE of claim 5, wherein the at least one processor is configured to cause the UE to:
receive second information for the first cell from the first NE in response to the handover to the first cell being started.

7. The UE of claim 6, wherein the at least one processor is configured to cause the UE to:
transmit information about network energy saving for the first cell to the first NE prior to receiving the first configuration.

8. The UE of claim 7, wherein the information about the network energy saving for the first cell comprises at least one of:
a second indication that the second information is misaligned with the first configuration;
a third indication that the second information is aligned with the first configuration;
a request for the first configuration; or
a fourth indication of the second information.

9. The UE of claim 7, wherein the at least one processor is configured to cause the UE to transmit the information about the network energy saving for the first cell on a set of dedicated physical random access channel resources.

10. The UE of claim 7, wherein the at least one processor is configured to cause the UE to transmit the information about the network energy saving for the first cell by:
transmitting an uplink message to the first NE, wherein the uplink message comprises the information about the network energy saving for the first cell and is associated with a random access procedure to the first cell or associated with a scheduling request.

11. The UE of claim 7, wherein the the at least one processor is configured to cause the UE to transmit the information about the network energy saving for the first cell by:
transmitting assistance information to the first NE, wherein the assistance information comprises the information about the network energy saving for the first cell.

12. A first network equipment (NE), comprising:
at least one memory; and
at least one processor coupled with the at least one memory and configured to cause the first NE to:
transmit, to a user equipment (UE) that performs a handover to a first cell provided by the first NE, a first configuration related to network energy saving for the first cell; and
communicate with the UE based on the first configuration.

13. The first NE of claim 12, wherein the at least one processor is configured to cause the first NE to transmit the first configuration during a random access procedure of the UE to the first cell or after the random access procedure.

14. The first NE of claim 13, wherein the at least one processor is configured to cause the first NE to:
transmit, to a second NE, a configuration for a time duration, wherein the second NE provides a source cell for the UE and wherein the UE monitors a downlink control channel for the time duration after successfully completing the random access procedure.

15. The first NE of claim 13, wherein the at least one processor is configured to cause the first NE to transmit the first configuration by:
transmitting at least one downlink message associated with the random access procedure, wherein the at least one downlink message comprises a first indication of the first configuration.

16. A method performed by a user equipment (UE), comprising:
performing a handover to a first cell provided by a first network equipment (NE); and
receiving from the first NE, downlink transmission in the first cell.

17. The method of claim 16, further comprising receiving the downlink transmission by monitoring a downlink control channel for a time duration after successfully completing a random access procedure to the first cell.

18. The method of claim 16, further comprising receiving the downlink transmission by:
receiving a first configuration related to network energy saving for the first cell during a random access procedure to the first cell or after the random access procedure; and
communicating with the first NE based on the first configuration.

19. A method performed by a first network equipment (NE), comprising:
transmit, to a user equipment (UE) that performs a handover to a first cell provided by the first NE, a first configuration related to network energy saving for the first cell; and
communicating with the UE based on the first configuration.

20. The method of claim 19, further comprising transmitting the first configuration during a random access procedure of the UE to the first cell or after the random access procedure.
